(19) United States
(12) Patent Application Publication
(10) Pub. No.: US 2007/0101026 A1
(43) Pub. Date: May 3, 2007

(54) BUS CONTROLLER AND DATA BUFFER SPACE CONFIGURATION METHOD OF THE SAME

(75) Inventors: Jiin Lai, Taipei (TW); Chun-Yuan Su, Taipei (TW); Yuan-Zong Cheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: VIA TECHNOLOGIES, INC., Taipei (TW)

(21) Appl. No.: 11/538,747

(22) Filed: Oct. 4, 2006

(30) Foreign Application Priority Data
Oct. 6, 2005 (TW) 094134994

(51) Int. Cl. G06F 3/00; G06F 5/00

(52) U.S. Cl. 710/8; 710/56

(57) ABSTRACT

In a data buffer space configuration method for requesting data from a target device via a bus, a device count of master device coupled to the bus is detected by the operating system. Then, a first data buffer space is configured to the master device if the device count is not greater than a threshold. On the other hand, a second data buffer space is configured to the master device if the device count is greater than the threshold.

### FIELD OF THE INVENTION

The present invention relates to a data buffer space configuration method; more particularly relates to a data buffer space configuring method adapted to a bus controller.

### BACKGROUND OF THE INVENTION

In a PCI (Peripheral Component Interconnect) bus system as depicted in FIG. 1, a master device 10 may request data from a target device 11 via the PCI bus 1, and then the target device 11 prepares and transmits the requested data to the master device 10 via the PCI bus 1.

During the data transmission from the target device 11 to the master device 10, the target device 11 could not realize the data length read by the master device 10 as the conventional data request issued by the master device 10 does not contain such information. Even if the data request might contain the information of requested data length, a considerable latency for the target device 11 to fetch corresponding data would be inevitable. Therefore, a pre-fetch method is adopted to solve the above-mentioned problems.

According to the pre-fetch method, data will be fetched in advance and temporarily stored in a data buffer 120 of the bus controller 12 for subsequent data transmission. On the condition that the PCI bus 1 is capable of supporting a plurality of bus devices serving as the master device 10, and the data buffer 120 includes a plurality of baskets for storing data of the corresponding master device 10.

For example, assuming that the PCI bus 1 is capable of supporting four master devices 10 and the data buffer 120 includes eight baskets (not shown), the data buffer space with two baskets is contributed to each master device averagely. However, if the latency of a certain master device is too long, the data buffer space with two baskets are not sufficient for buffering the data. Once the data buffer space is full, the certain master device has to release the bus to other master devices. If there are 3 or more master devices coupled to the PCI bus 1 at the same time, when the master device releases the use of the PCI bus 1, there is a great chance that another master device could use the PCI bus 1 immediately, so the bus utilization is high. However, if there are just a few master devices coupled to the PCI bus 1, for example only one or two, the bus utilization would be significantly reduced due to the idle bus resulting from the facts that the master device with data buffer space fully occupied releases the use of the bus but no other master device would use the bus instead.

### SUMMARY OF THE INVENTION

A configuration method of data buffer space applied to a master device coupled to a bus for buffering the data requested from a target device, includes: detecting a device count of the master devices coupled to the bus; detecting a device count of the master device coupled to the bus, and them configuring a first data buffer space to the master device when the device count is not greater than a threshold, on the other hand configuring a second data buffer space to the master device when the device count is greater than the threshold.

A bus controller for configuring data buffer space for a master device coupled to a bus for buffering the data requested from a target device includes: a data buffer having a plurality of buffer sets for providing data buffer space of the master device, a data buffer control logic circuit coupled to the data buffer for configuring data buffer space of the master device according to a device count of the master device coupled to the bus; and a selecting device, coupled to the data buffer and the data buffer control logic circuit for selecting the buffer sets contributed to the master device according to a selecting signal from the data buffer control logic circuit.

A PCI bus system includes: a target device, coupled to the PCI bus, at least one master device for requesting data from the target device via the PCI bus; and a bus controller coupled between the PCI bus and the master device, wherein the bus controller comprises a data buffer for providing data buffer space to the master device for buffering the data from the target device. In the invention, a first data buffer space is configured to the master device when a device count of the master device is not greater than a threshold, and a second data buffer space is configured to the master device when the device count of the master device is greater than the threshold.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram schematically illustrating a PCI bus architecture, via which a master device can request data from a target device;

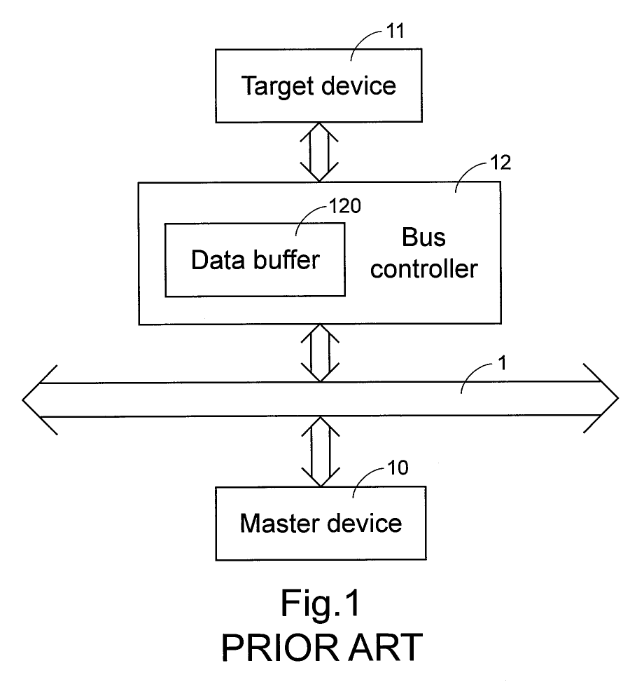

FIG. 2 is a functional block diagram schematically illustrating a PCI bus architecture that support up to four master devices to request data from a target device;

FIG. 3 is a flow chart of a data buffer allocation method according to an embodiment of the present invention;

FIG. 4(a) is a functional block diagram exemplifying a bus controller according to an embodiment of the present invention, which serve four master devices; and

FIG. 4(b) is a functional block diagram exemplifying a bus controller according to an embodiment of the present invention, which serves only two master devices.

### DETAILED DESCRIPTION OF THE PREFERRED EMBODIMENT

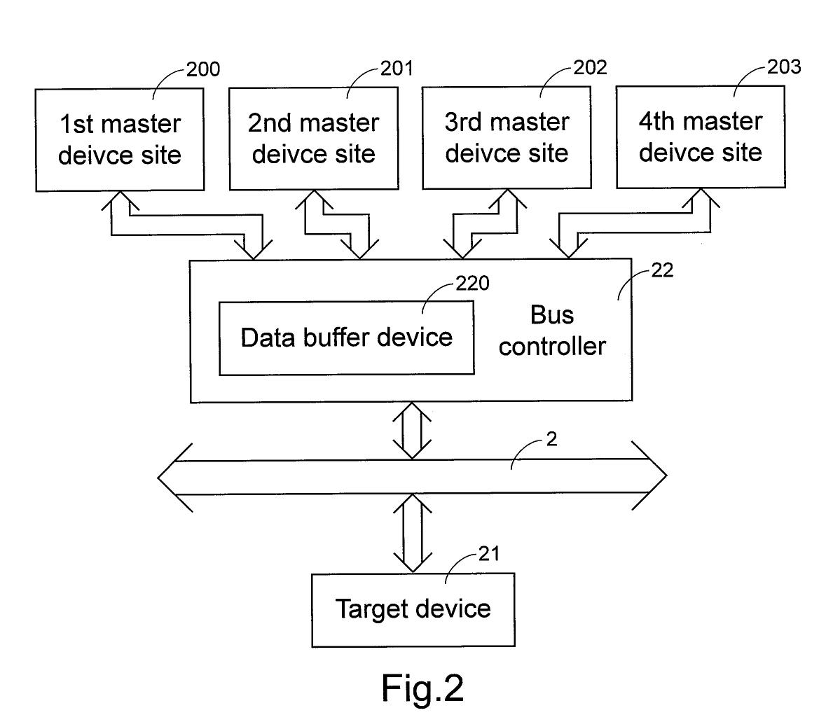

A data buffer space configuration method according to an embodiment of the present invention is exemplified under the PCI bus system of FIG. 2. In the embodiment, assuming the bus system supports at most four master devices 200˜203, each master device 200˜203 would request data from a target device 21 via the bus 2 and the bus controller 22. The bus controller 22 has a data buffer 220 with a plurality of data buffer units. In the embodiment, assume the data buffer 220 has eight data buffer baskets (basket 0, basket 1 . . . basket 7) and each data buffer basket has a size of 8QW (quad-word). The data buffer 220 provides the corresponding data buffer space for each of the master device 200˜203 respectively for storing the pre-fetched data from the target device 21. The eight buffer units of data buffer 220 are grouped into four buffer sets (i.e. a basket (0, 1) buffer set, a basket (2, 3) buffer set, a basket (4, 5) buffer set and a basket (6, 7) buffer set) and optionally contributed to the master devices 200˜203 according to the condition of bus usage.

In the present invention, the bus system as described above could be a PCI bus system.

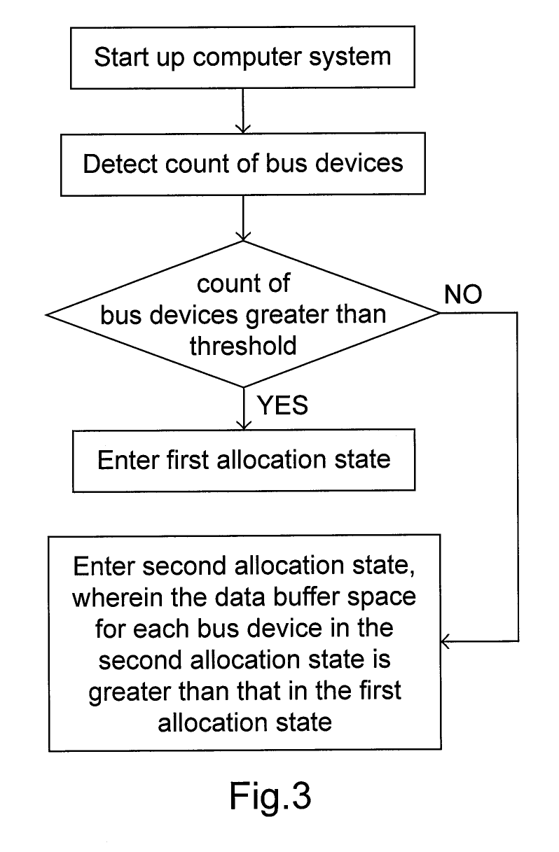

FIG. 3 depicts the flow chart of the embodiment of the data buffer space configuration method. After a computer system is booted, the operating system scans the bus system to determine how many master devices are coupled to the bus 2, and then informs the bus controller 22 of the device count of the detected master device. Afterwards, the bus controller 22 configures a first data buffer space to the master device when the device count of the detected master devices is not greater than a threshold, or configures a second data buffer space to the master device when the device count of the detected master device is greater than the threshold. The threshold is preset according to the maximum count of the master device that the bus system supports.

For example, if the threshold is two and the device count of the master device physically coupled to the bus 2 is not greater than two, the bus controller 22 respectively configures the first data buffer space to each coupled master device. On the other hand, if the device count of the detected master devices is greater than two, the bus controller 22 respectively configures the second data buffer space to each coupled master device.

In different configurations of data buffer space, the data buffer baskets are contributed in different manners so that the data buffer space configured to each coupled master device is different in two cases. As a result, the first data buffer space is greater than that the second data buffer space.

In this manner, the bus utilization can be improved. For example, when there are only two master devices, e.g. master devices 200 and 201, coupled to the bus 2, the bus controller 220 configures the first data buffer space with two buffer sets (i.e. four data buffer baskets) to each of the master device 200 and 201. In other words, the buffer sets originally supposed to serve the master devices 202 and 203 are released to the master devices 200 and 201. Therefore, the bus system will not be usually idle due to the more data buffer space is configured to the master device when less master devices are coupled to the bus. In the embodiment, assume the buffer set (0, 1) and the buffer set (4, 5) are contributed to the first master device 200, and the buffer set (2, 3) and the buffer set (6, 7) are contributed to the second master device 201 for data fetching and data transmission.

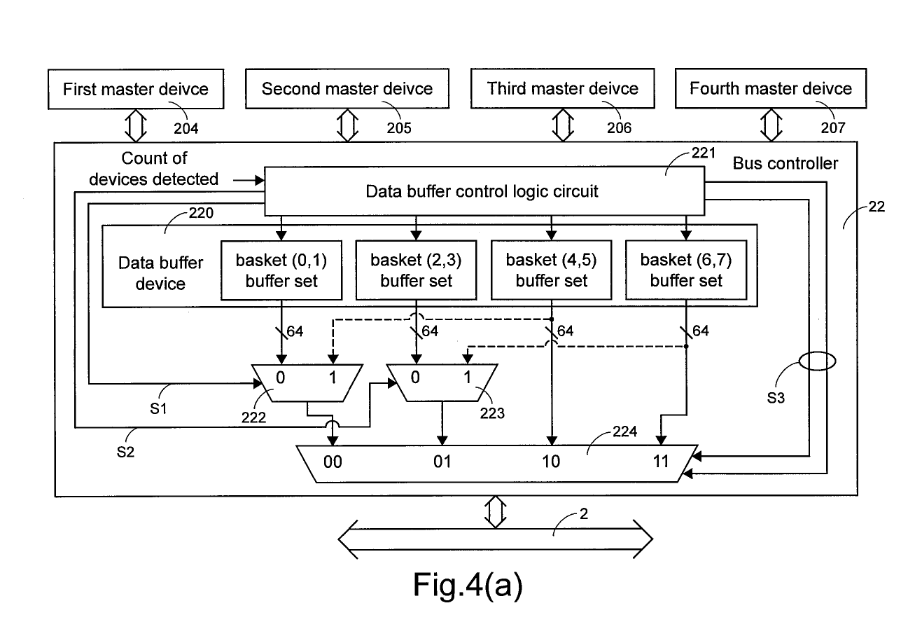

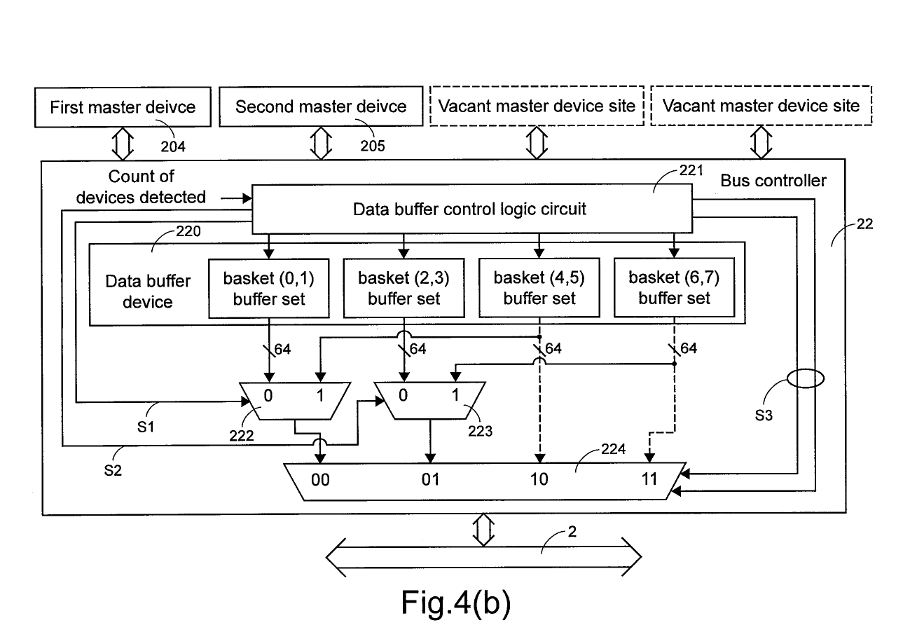

FIGS. 4(a) and 4(b) give examples for contributing buffer sets by an embodiment of a bus controller according to the present invention. The bus controller 22 includes a data buffer control logic circuit 221, a data buffer 220 including eight data buffer units from basket 0 to basket 7 or four buffer sets, i.e. buffer set (0, 1), buffer set (2, 3), buffer set (4, 5) and buffer set (6, 7), a multiplexer 222˜224. The device count of master device physically coupled to the bus system is detected by the operating system for configuring the data buffer space of the master device.

In the example of FIG. 4(a), assuming that there are the four master device 204˜207 coupled to the bus 2 via the bus controller 22, the data buffer control logic circuit 221 configures the second data buffer space to each master device 204˜207. In such condition, assume that the buffer set (0, 1), the buffer set (2, 3), the buffer set (4, 5) and the buffer set (6, 7) are averagely specific to the first master device 204, the second master device 205, the third master device 206 and the fourth master device 207, respectively. Meanwhile, the selection signal S1 for the multiplexer 222 is kept at logic “0”, the selection signal S2 for the multiplexer 223 is kept at logic “0”, and the selection signal S3 for the multiplexer 224 can be logic “00”, “01”, “10” or “11”, depending on which of the master devices is served.

In the example of FIG. 4(b), assuming that only two master devices 204 and 205 are coupled to the bus 2 via the bus controller 22, the data buffer control logic circuit 221 configures the first data buffer space to each master device 204 and 205. In such condition, the buffer set (0, 1) and the buffer set (4, 5) are contributed to the first master device 204 while the buffer set (2, 3) and the buffer set (6, 7) are contributed to the second master device 205. When the selection signal S1 for the multiplexer 222 is at logic “0”, and the selection signal S3 for the multiplexer 224 is at logic “00”, it means the first master device 204 is served and the buffer set (0, 1) buffer set is used to fetch and transmit data. On the other hand, when the selection signal S1 for the multiplexer 222 is at logic “1”, and the selection signal S3 for the multiplexer 224 is at logic “00”, it means the first master device 204 is still served but it is the buffer set (4, 5) buffer set used to fetch and transmit data. Likewise, when the selection signal S2 for the multiplexer 223 is at logic “0”, and the selection signal S3 for the multiplexer 224 is at logic “01”, it means the second master device 205 is served and the buffer set (2, 3) buffer set is used to fetch and transmit data. On the other hand, when the selection signal S2 for the multiplexer 223 is at logic “1”, and the selection signal S3 for the multiplexer 224 is at logic “01”, it means the second master device 204 is still served but it is the buffer set (6, 7) buffer set used to fetch and transmit data. In this dynamically adjusting manner, the undesired idle situation can be remedied to a great extent.

Although the present invention is illustrated with the example of four master device sites and eight buffer units, it is understood that the present data buffer configuration method can be applied to various counts of master devices and data buffer. Generally, the count of data buffer basket is a multiple of the maximum count of the master devices supported by the bus. When the counts of master devices and data buffer basket change, the count and/or disposition of multiplexers may change accordingly. Meanwhile, there might be more than two kinds of data buffer space configurations when the counts of master devices and data buffer units is large, thereby making the data buffer space configuration more flexible.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A data buffer space configuration method for a master device coupled to a bus, comprising:
detecting a device count of the master device coupled to the bus; and
configuring a first data buffer space to the master device when the device count is not greater than a threshold, and configuring a second data buffer space to the master device when the device count is greater than the threshold.

2. The method according to claim 1, wherein the first data buffer space is greater than the second data buffer space.

3. The method according to claim 1, wherein each of the first data buffer space and the second data buffer space is contributed from a plurality of buffer sets.

4. The method according to claim 2, comprising contributing at least one buffer set to the master device when the device count is not greater than the threshold, and contributing one buffer set to the master device when the device count is greater than the threshold.

5. The method according to claim 2, wherein the total of the buffer sets are 4, and the data buffer space with 2 buffer sets is contributed to the master device when the device count is not greater than 2, and the data buffer space with 1 buffer set is contributed to the master device when the device count is greater than 2.

6. The method according to claim 1, wherein the device count is detected by an operating system after a computer system is booted.

7. The method according to claim 1, wherein the threshold is preset according to the maximum count of the master device that the bus is able to support.

8. The method according to claim 1, wherein the method is executed by a bus controller.

9. A bus controller for configuring data buffer space for a master device coupled to a bus for buffering the data requested, comprising:
a data buffer with a plurality of buffer sets for providing data buffer space for the master device;
a data buffer control logic circuit coupled to the data buffer for configuring data buffer space for the master device according to a device count of the master device coupled to the bus; and
a selecting device, coupled to the data buffer and the data buffer control logic circuit for selecting the buffer sets contributed to the master device according to a selection signal from the data buffer control logic circuit.

10. The bus controller according to claim 9, wherein the data buffer control logic circuit contributes at least one buffer set to the master device when the device count is not greater than a threshold; and the data buffer control logic circuit contributes one buffer set to the master device when the device count is greater than the threshold.

11. The bus controller according to claim 9, wherein the selecting device comprises a least one multiplexers, respectively coupled to at least one of the buffer sets for selecting the buffer sets contributed to the master device according to the selection signal

12. The bus controller according to claim 9, wherein the threshold is 2, the total of the buffer sets are 4, and the data buffer control logic circuit configures the data buffer space with 2 buffer sets to the master device when the device count is not greater than the threshold, and the data buffer control logic circuit configures the data buffer space with 1 buffer set to the master device when the device count is greater than the threshold.

13. The bus controller according to claim 12, wherein the selecting device selects 2 buffer sets to the master device when the device count is not greater than the threshold, and the selecting device selects 1 buffer set to the master device when the device count is greater than the threshold.

14. The bus controller according to claim 9, wherein the threshold is preset according to the maximum count of the master device that the bus is able to support.

15. The bus controller according to claim 9, wherein the device count of the master device coupled to the bus is determined by an operating system after a computer system is booted.

16. A PCI bus system, comprising:
a target device, coupled to the PCI bus;
at least one master device for requesting data from the target device via the PCI bus; and
a bus controller coupled between the PCI bus and the master device, wherein the bus controller comprises a data buffer for providing data buffer space to the master device for buffering the data from the target device;
wherein a first data buffer space is configured to the master device when a device count of the master device is not greater than a threshold, and a second data buffer space is configured to the master device when the device count of the master device is greater than the threshold.

17. The PCI bus system according to claim 16, wherein the bus controller further comprises a data buffer control logic circuit for configuring the data buffer space to the master device.

18. The PCI bus system according to claim 16, wherein the data buffer comprises a plurality of buffer sets, the first data buffer space with at least one buffer set is contributed to the master device when the device count of the master device is not greater than the threshold, and the second data buffer space with one buffer set is contributed to the master device when the device count of the master device is greater than the threshold.

19. The PCI bus system according to claim 18, wherein the bus controller further comprises a selecting device for selecting buffer sets contributed to the master device.
